(19) United States
(12) Patent Application Publication
(10) Pub. No.: US 2012/0254225 A1
(43) Pub. Date: Oct. 4, 2012

(54) GENERATING CONTENT BASED ON PERSONA

(75) Inventors: Bernadette A. Carter, Raleigh, NC (US); Al Chakra, Apex, NC (US); Oriana Love, Richland, WA (US)

(73) Assignee: INTERNATIONAL BUSINESS MACHINES CORPORATION, ARMONK, NY (US)

(21) Appl. No.: 13/077,247

(22) Filed: Mar. 31, 2011

(51) Int. Cl. G06F 17/30

(52) U.S. Cl. 707/769; 707/E17.014

(57) ABSTRACT

According to one aspect of the present invention, a method, operable on a processing device, for generating content based on a persona, the persona comprising one or more persona triggers and one or more persona parameters, may include analyzing, by the processing device, one or more events identified by one or more persona triggers resulting in one or more event characteristics. The method may also include performing, by the processing device, a comparison between the one or more event characteristics and one or more persona parameters. The method may also include generating content, by the processing device, based at least in part on the comparison between the one or more event characteristics and the one or more persona parameters.

### BACKGROUND

Aspects of the present invention relate to content generation, and more particularly to a method, system and computer program product for content generation based on a persona.

In current times, content is distributed from a variety of types of services many of which including a very high number of sources. For example, content is generated by online newspapers printing articles electronically and content is also generated by a number of online readers of those stories commenting about the stories either using a commenting feature provided by the publisher of the article, using a social media network, or otherwise. The subject matter of content spans across every field as Internet blogs, chat rooms, and social media networks or groups of users within social media networks direct their focus on particular topic areas and/or events.

Sorting through relevant and interesting content can be a daunting task for a person. Furthermore, determining content relevant to the person's interests and prompting a response from the user may be even more difficult when considering the large amount of content available. Accordingly, assistance in finding worthwhile content, and specifically content prompting a response from the user, as well as assistance in generating appropriate responses based on the user's pattern for responding to similar content would be useful. Therefore, a system and method for generating content based on a persona is needed.

### BRIEF SUMMARY

According to one aspect of the present invention, a method, operable on a processing device, for generating content based on a persona, the persona comprising one or more persona triggers and one or more persona parameters, may include analyzing, by the processing device, one or more events identified by one or more persona triggers resulting in one or more event characteristics. The method may also include performing, by the processing device, a comparison between the one or more event characteristics and one or more persona parameters. The method may also include generating content, by the processing device, based at least in part on the comparison between the one or more event characteristics and the one or more persona parameters.

According to another aspect of the present invention, a processing device for generating content based on a persona, the persona comprising one or more persona triggers and one or more persona parameters, may include a processor. The processor may be configured to operate a module for analyzing one or more events identified by one or more persona triggers resulting in one or more event characteristics. The processor may also be configured to operate a module for performing a comparison between the one or more event characteristics and one or more persona parameters. The processor may also be configured for generating content based at least in part on the comparison between the one or more event characteristics and the one or more persona parameters.

According to another aspect of the present invention, a computer program product for generating content based on a persona, the persona comprising one or more persona triggers and one or more persona parameters, may include a computer readable storage medium having computer readable program code embodied therewith. The computer readable program code may include computer readable program code configured to analyze one or more events identified by one or more persona triggers resulting in one or more event characteristics. The computer readable program code may include computer readable program code configured to perform a comparison between the one or more event characteristics and one or more persona parameters. The computer readable program code may include computer readable program code configured to generate content based at least in part on the comparison between the one or more event characteristics and the one or more persona parameters.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a flowchart of an example of a method 100 for creating a persona.

FIG. 2 is a flowchart of an example of a method 200 for generating content based on a persona in accordance with another embodiment of the present invention.

FIG. 3 is a block schematic diagram of an example of a system 300 for generating content based on a persona in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

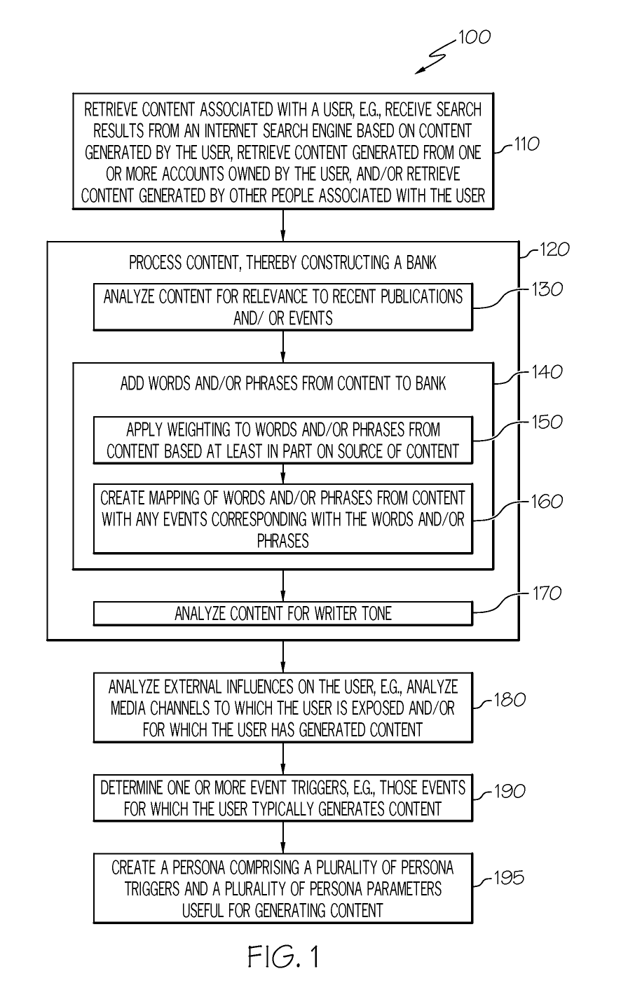

FIG. 1 is a flowchart of an example of a method 100 for creating a persona. In block 110, a processing device retrieves content associated with a user. In some embodiments, the content is retrieved from one or more content providers. As an example, the processing device may receive search results from an Internet search engine based on content generated by one or more accounts owned by the user, such as by keyword searching. In some embodiments, the processing device retrieves content generated by one or more people other than the user. The people other than the user may be determined based on the user's social network, such as those people with whom the user interacts via one or more social media networks. One motivation for retrieving content generated from people other than the user may be that people associated via social media networks tend to be interested in similar content, publish similar content, and/or the like.

In some embodiments, the processing device constructs a timeline of previous and current events in addition to content publications made by the user. A timeline generation tool, such as the dipity tool (http://www.dipity.com), may be used to combine headline events and personal content generated by the user. Such content may originate from various social media networks, such as, for example, twitter, facebook, blogger and the like. Such content may also originate from various other sources, such as more formal sources like formal news outlets. In some embodiments, the user as well as other users associated with the initial user in a community relationship, such as a friends network on a social media network, input events of interest. In some embodiments, the community may input links to corresponding relevant content, such as, for example, articles, videos, pictures or the like that describe or relate to the event.

The processing device may create a master timeline of all the events inputted by the user and/or the community as well as the content generated by the user and none, some or all the content generated by none, some or all the user's social network as defined by none, one or more of the user's social media networks. For example, the master timeline may include all content generated by the user as well as all content generated by the user's immediate family as determined by accessing one or more of the user's social media networks, such as facebook. In some embodiments, the processing device may be configured to retrieve content based on the headlines of news sources, such as, for example, content published by CNN, Fox News, or the like. The news sources may be selected by the user in some embodiments, and in other embodiments the news sources may be predetermined by the processing device and/or a managing entity of the system. In some embodiments, the processing device determines events to add to the timeline based on overlap of content among two or more pieces of content published by different members of the user's community and/or headlines or within the body of content generated by a more formal source, such as a news source.

In block 120, a processing device processes the content retrieved in block 110. As illustrated in FIG. 1, the step represented by block 120 may include several sub-steps, as represented by blocks 130, 140, 150, 160, and 170. In block 130, the processing device analyzes content for relevance to recent publications and/or events. Such analysis may include matching keywords from the content with keywords from recent publications and/or events.

In block 140, the processing device adds words and/or phrases from the content to a content bank. The words and/or phrases may be stored in the file system 306 of the processing device 302. In some embodiments, the bank is created based at least in part on a timeline created as detailed above. The processing device may analyze each piece of available content and then add the words and/or phrases to the persona dictionary or bank.

Furthermore, in some embodiments, the processing device may be configured to analyze the words within the content for capitalization, frequency of user, and source. This analyze may be saved by the processing device as characteristic of the content generated by the user, such that during subsequent content generation steps, the user's style may be mimicked.

The step represented by block 140 may include several sub-steps, as represented by block 150 and 160. In block 150, the processing device applies weighting to words and/or phrases from content based at least in part on the source of the content. For example, content retrieved from a social media network may be weighted less than content retrieved from more formal publications, such as blogs and/or articles. As another example, content retrieved from people other than the user may be weighted less than content generated by the user. In this regard, the content bank includes a variety of content in various embodiments including content generated by the user, the user's associates, content generated for formal publications and/or content generated for informal publication, such as a social media network message and/or publication. In some embodiments, oral communications from the user are also analyzed in step 130 and added to the bank in step 140. For example, the user records and publishes an audio comment regarding a current event, such as a political, social, sporting or some other current event. The audio comment may be analyzed using audio to text conversion software and keywords from the audio content may be included in the bank.

In block 160, the processing device creates a mapping of words and/or phrases from the content with any events corresponding with the words and/or phrases. The mapping may include references between particular words and/or phrases and particular types of events, such as specific sporting events and/or political events.

In some embodiments, the processing device may create a mapping between each word and/or phrase in the bank with one or more events with which the word or phrase is associated. Likewise, in some embodiments, the processing device may create a mapping between each word and/or phrase in the bank with one or more pieces of content from which the word and/or phrase originated. Words and/or phrases containing capital letters, special formatting, quotations, or the like may be tied to the corresponding event by a weighting that is higher than a weighting applied to, for example, words and/or phrases without capital letters, special formatting, quotations, or the like.

In some embodiments, the processing device is configured to perform a comparison between one or more tags and/or one or more keywords within the content to various events of interest or events exhibiting a high likelihood of mapping to words and/or phrases from the content. The likelihood of mapping may be determined, in various embodiments, based on similar events or related events already having been mapped to the particular content or words and/or phrases from the content. In some embodiments, the processing device analyzes all the events known to the system for association with one or more tags or keywords. In some embodiments, a weighting is applied to the comparison such that events having a higher correlation to the content are included in the mapping, whereas events having a lower correlation to the content are not included in the mapping. In some embodiments, those events occurring within a predetermined period of time of the content being published are analyzed for inclusion in the mapping, whereas those events occurring outside the predetermined period of time are not considered for inclusion. In some embodiments, the closer to publication of the content that the event occurred, the higher weighting that particular event is given for inclusion in the mapping, whereas the farther away in time from the publication of the content that the event occurred, the lower weighting that particular event is given for inclusion in the mapping. For example, if an event occurred within a week of the content generation it may receive a lower weighting than an event that occurred within a day of the content publishing or within an hour of the content publishing. In some embodiments, content outside a predetermined period of time from an event occurring is excluded from consideration for inclusion in the mapping.

In some embodiments, the events being considered for mapping with words and/or phrases pulled from content may be or include response to other content such as responses to published article or blog posts. In some instances, the events being considered may be relatively simple, such as a comment posted in response to a blog post, or the events being considered for inclusion may be relatively sophisticated, such as a publication by the Associated Press or other news service.

In some embodiments, the processing device is configured to analyze content corresponding to events in order to capture the likelihood of the user writing a post based upon previous responses and the responses, or lack thereof, of other members in the user's social network. In some embodiments, this analysis includes consideration of percentages of responses based on the type or class of the event. For example, in some embodiments, the type or class of event may be based on topic, keywords, or the user(s) who generated the content regarding the event. Based on these analyses, if the processing device determines that a user, for example, creates a supportive micro-blog entry 90% of the time when content is published having a negative tone with regard to a specific person, then the processing device, during subsequent content generation, will construct a micro-blog sentence having a positive tone and referencing the person.

In block 170, the processing device analyzes content for writer tone. The writer's tone may be included in the mapping discussed above with reference to block 160. That is, the writer's tone when generating content with regard to a particular subject or type of content may be mapped such that the processing device will subsequently be capable of retrieving the mapping indicating the writer's tone when generating content regarding a particular topic or subject.

In some embodiments, the processing device may be configured to analyze the content based on the sentiment exhibited within the content, thereby interpreting the perception of certain events by the user. Likewise, in some embodiments, the sentiment of the content generated by the user's social network may be analyzed in order to interpret the perception of a particular event by the user's social network. In this regard, the user's perception of a particular event may be compared to the perception of a particular event to the user's social network in general and/or one or more members of the user's social network. Examples of tone include negative, optimistic, apathetic, positive, and/or others.

In additional to the sentiment or tone, the processing device also captures the writer's viewpoint with regard to content being mapped. In various embodiments, occurrences within the user's life are also considered events or used in mapping other events. In some embodiments, the mapping of step 160 combines analysis of the tone of the writer and the viewpoint to the event and/or topic being addressed.

In some embodiments, the processing device refers to the timeline of events and performs a historical analysis of the events within the timeline. For example, in some embodiments, the processing device is configured to determine how the viewpoints of the user's content have changed over time. In some instances, patterns are determined, such as a pattern of similarities or differing viewpoints of the user over time. In another example, the user's viewpoints are compared to those viewpoints of members in the user's social network, and patterns of agreement and/or disagreement between the user's viewpoints and viewpoint(s) of the member(s) of the social network may be determined. In some embodiments, the processing device may be configured to determine whether the patterns are increasing or decreasing over time as the user interacts with specific people or sources.

In block 180, the processing device analyzes external influences on the user. For example, in some embodiments the processing device analyzes media channels to which the user is exposed in order to determine the scope of media available to the user. The external influences may include particular podcasts, television programming, radio programming, websites and the like. Such analysis may provide incite into the types of events and/or publications in which the user is interested, and therefore exposed.

In block 190, the processing device determines one or more event triggers. For example, the event triggers may indicate those events and/or publications for which the user typically generates content. Thus, when the processing device is subsequently generating content based on the persona, an initial step before generating the content may be to determine whether an event trigger has occurred indicating that the user would typically generate content.

In block 195, the processing device creates a persona based on the content, the word bank and/or the mapping in various embodiments. The persona may include one or more parameters usable for subsequent generation of content. The persona may also include one or more persona triggers useful for indicating initial content for which the persona would typically generate new content responsive to the initial content, for example, a response to a message. The one or more parameters may be created based on the processing of the content and the other analyses, such as analysis of external influences and the like, as discussed with reference to block 120 and others. Specifically, in some embodiments, the parameters may include one or more parameters indicating the types of content typically generated given a particular type or subject of publication and/or event. In some embodiments, the parameters may include one or more parameters indicating the types of content typically generated in response to various sources of initial content. In some embodiments, the parameters may include information regarding historical publishing frequency with regard to the user's various types of content generation. For example, the user may average five micro-blog posts a day related to some topic, whereas the user may average one blog post a day related to that topic.

In some embodiments, the parameters include information related to the user's known political, religious, moral or other viewpoints. Such viewpoints may be determined based on the various analyses of the user's generated content in and/or may be determined based on explicit assertion of the user's viewpoints, such as by the user's direct input of the information. Such information, in some embodiments, may be extracted from one or more social media networks, such as facebook. In some embodiments, the mapping and persona includes consideration of external content generation patterns, such as content generated by social media community members. The persona may include such consideration as well as determination of the type and viewpoint of the content that should be generated in response to specified events.

In some embodiments, the persona is an ever-changing entity, such that content is continuously analyzed, the bank is continuously updated and the mapping is likewise continuously updated. In this regard, current trends of the user are detected and taken into consideration as the person is used to generate content for publication.

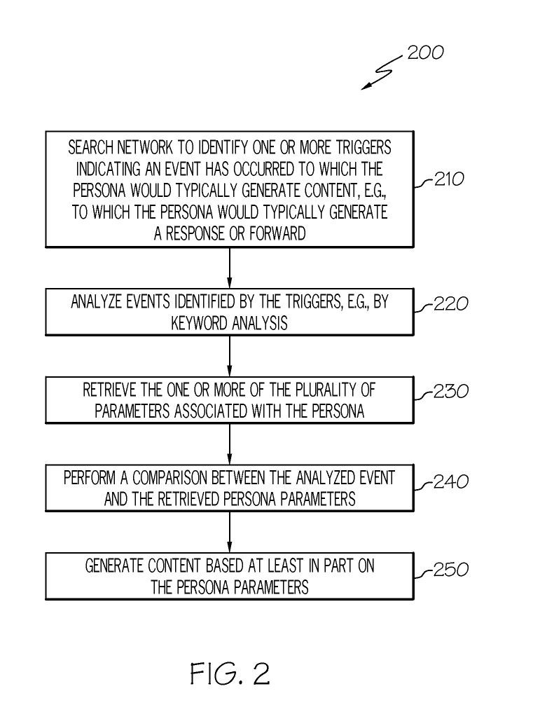

Referring now to FIG. 2, a flowchart of an example of a method 200 for generating content based on a persona is shown. In block 210, a processing device searches a network to identify one or more triggers or persona triggers indicating an event has occurred to which the persona would typically generate content. For example, an event to which the persona would typically generate a response message and/or a forward message.

In block 220, the processing device analyzes one or more events identified by the triggers. For example, in some embodiments, the analysis includes a keyword analysis. In block 230, the processing device retrieves one or more of the plurality of parameters associated with the persona, referred to as persona parameters. In block 240, the processing device performs a comparison between the analyzed event and the retrieved persona parameters. In block 250, the processing device generates content based at least in part on the results of the comparison between the analyzed event and the persona parameters.

Thus, after an event has been analyzed and deemed appropriate for a persona response, the processing device generates content on the persona's behalf. A content generation engine may be used to generate the content and may be augmented to take into account the persona's style and sentiment. Such augmentations are based, in various embodiments, on the parameters created for the persona, the word bank and the mapping of events with specific words and/or phrases.

In some embodiments, the processing device provides the user a preview of the draft content. In some such embodiments, the processing device receives user input with regard to modifications regarding the draft content. In other embodiments, the processing device is configured to publish the generated content automatically in some or all situations. In some embodiments, the generated content may be published automatically if it falls within predetermined criteria and communicated to the user for review and editing if necessary and if it falls outside predetermined criteria for automatic publication. For example, in some embodiments, the generated content is automatically published if is a micro-blog or blog, but the generated content is communicated to the user if the generated content is a response to a blog. In various other embodiments or applications, various other configurations for automatic content are used.

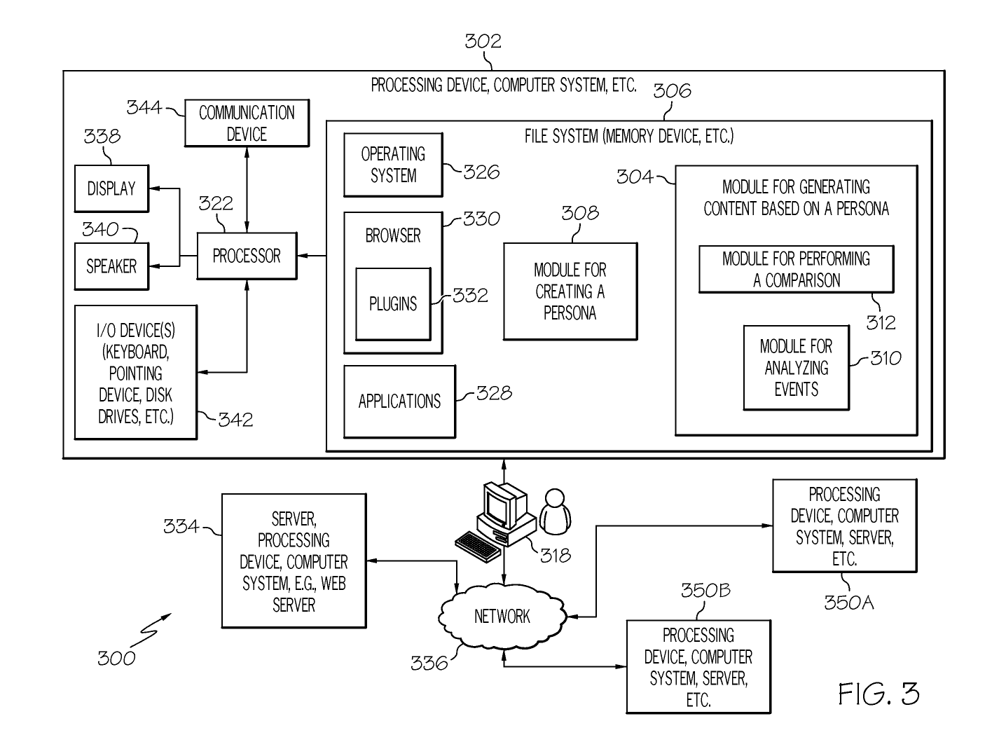

FIG. 3 is a block schematic diagram of an example of a system 300 for generating content based on a persona in accordance with an embodiment of the present invention. The methods 100 and 200 of FIGS. 1 and 2, respectively, may be embodied in or performed by the system 300. The system 300 may include a processing device 302. The processing device 302 may be a computer system, or similar processing device. A module 304 for generating content based on a persona may be stored on the processing device 302 and may be operable on the processing device 302 for generating content based on a persona similar to that described herein. The module 304 may be stored on a file system 306 of the processing device 302. Portions of or all of the methods 100 and/or 200 may be embodied in or performed by the module 304. In some embodiments, some or all of method 200 may be embodied in or performed by the module 304.

A module 308 for creating a persona may also be stored on the processing device 302 and may be operable on the processing device 302 for creating a persona similar to that described herein. The module 308 may be stored on a file system 306 of the processing device 302. Portions of or all of the methods 100 and/or 200 may be embodied in or performed by the module 308. In some embodiments, module 308 embodies or performs some or all of method 100 and module 304 embodies or performs some or all of method 200. Specifically, the module 308 for creating a persona may perform operations similar to those described with reference to blocks 110, 120, 130, 140, 150, 160, and/or 170 of FIG. 1, and/or other operations, and the module 304 for generating content based on a persona may perform operations similar to those described with reference to blocks 210, 220, 230, 240, and/or 250 of FIG. 2 and/or other operations.

The module 304 for generating content based on a persona may include a module for performing a comparison 312. The module for performing a comparison 312 may perform operations similar to that described with reference to block 240 in FIG. 2, among other operations. The module 304 for generating content based on a persona may also include a module 310 for analyzing events. The module 310 for analyzing events may perform operations similar to those described with reference to block 220 of FIG. 2, among other operations.

A user 318 of the system 300, may use the processing device, which is, for example, a computer system, to access module 304 for generating content based on a persona. The processing device 302 may include a processor 322 to control operation of the processing device 302 and the file system 306, such as, for example, a memory device. An operating system 326, applications 328 and other programs, such as a browser 330 having one or more plugins 332 installed on the browser may be stored on the file system 306 for running or operating on the processor 322. The browser 330, such as a web or Internet browser, may be configured for accessing the processing device 302 directly or server 334, for example, a web server, via a network 336 for accessing websites, retrieving content, publishing newly generated content and other operations discussed herein, controlling operation of modules 308, 304, 312, and/or 310, or for other purposes related to generating content based on a persona. The network 336 may be the Internet, an intranet or other private or proprietary network.

The processing device 302 may also include a display 338, a speaker system 340, and one or more input devices, output devices or combination input/output devices, collectively I/O devices 342. The I/O devices 342 may include a keyboard, pointing device, such as a mouse, disk drives and any other devices to permit a user, such as user 318, to interface with and control operation of the processing device 302 and to access the module 308 and/or module 304 or one or more components of the system 300 or other components, systems or servers, for generating content based on a persona. The processing device 302 may also include a communication device 344 configured to receive instructions from the processor 322 and configured to communicate across the network 336 with the server 334 autonomously or in conjunction with the browser 330 and/or any other systems, processing devices and/or computer systems and/or one or more of the modules of the system.

The processing device 302 may also communicate over the network 336 with one or more datastores 348, which, as discussed above, may be or may include one or more databases and/or one or more servers, processing devices, computer systems or other device, configured to communicate with one or more other processing devices, such as processing devices 350A and 350B. In some embodiments, the datastore 348 communicates via network 336 with the one or more processing devices. As discussed above, the datastore 348 is configured to receive and store one or more pieces of content generated by one or more sources such as a processing device, computing device or otherwise.

In accordance with embodiments of the present invention, a method, operable on a processing device, for generating content based on a persona, the persona comprising one or more persona triggers and one or more persona parameters, may include analyzing, by the processing device, one or more events identified by one or more persona triggers resulting in one or more event characteristics. The method may also include performing, by the processing device, a comparison between the one or more event characteristics and one or more persona parameters. The method may also include generating content, by the processing device, based at least in part on the comparison between the one or more event characteristics and the one or more persona parameters.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

1. A method, operable on a processing device, for generating content based on a persona, the persona comprising one or more persona triggers and one or more persona parameters, the one or more persona triggers each indicate an event has occurred and generating content by the persona in response to the event occurring, the method comprising:
analyzing, by the processing device, one or more events identified by one or more persona triggers resulting in one or more event characteristics;
performing, by the processing device, a comparison between the one or more event characteristics and one or more persona parameters; and
generating content, by the persona on the processing device, based at least in part on the comparison between the one or more event characteristics and the one or more persona parameters.

2. The method of claim 1, further comprising:
searching a network to identify one or more of the persona triggers indicating the event has occurred to which the persona generates content.

3. The method of claim 1, further comprising:
retrieving the one or more persona triggers and the one or more persona parameters from a storage device.

4. The method of claim 1, further comprising:
retrieving source content from one or more content providers; and
processing the source content to create the persona.

5. The method of claim 4, wherein processing the source content to create the persona comprises:
processing the source content to create at least one of the one or more persona parameters.

6. The method of claim 4, wherein processing the source content to create the persona comprises:
processing the source content to create at least one of the one or more persona triggers.

7. The method of claim 4, wherein processing the source content to create the persona comprises:
analyzing the content for relevance to recent publications or events.

8. The method of claim 4, wherein processing the source content to create the persona comprises: adding words from the content to a dictionary comprising:
applying weighting to words from the content based at least in part on the source of the content; and
creating a mapping of the words from the content based at least in part on the events corresponding with the words.

9. The method of claim 4, wherein processing the source content to create the persona comprises:
analyzing the content for the tone of the writer.

10. A processing device for generating content based on a persona, the processing device comprising:
a processor;
a module operable on the processor for generating content based on the persona, the persona comprising one or more persona triggers and one or more persona parameters, the one or more persona triggers each indicate an event has occurred and generating content by the persona in response to the event occurring, the module comprising:
a module for analyzing one or more events identified by one or more persona triggers resulting in one or more event characteristics;
a module for performing a comparison between the one or more event characteristics and one or more persona parameters; and
a module for generating content based at least in part on the comparison between the one or more event characteristics and the one or more persona parameters.

11. The processing device of claim 10, wherein the module operable on the processor for generating content based on the persona further comprises:
a module for searching a network to identify one or more of the persona triggers indicating the event has occurred to which the persona generates content.

12. The processing device of claim 10, wherein the module operable on the processor for generating content based on the persona further comprises:
a module for retrieving source content from one or more content providers;
and
a module for processing the source content to create the persona.

13. The processing device of claim 12, wherein the module operable on the processor for generating content based on the persona further comprises:
a module for processing the source content to create at least one of the one or more persona parameters.

14. The processing device of claim 12, wherein the module operable on the processor for generating content based on the persona further comprises:
a module for processing the source content to create at least one of the one or more persona triggers.

15. The processing device of claim 12, wherein the module operable on the processor for generating content based on the persona further comprises:
a module for analyzing the content for relevance to recent publications or events.

16. The processing device of claim 12, wherein the module operable on the processor for generating content based on the persona further comprises:
a module for adding words from the content to a dictionary comprising:
a module for applying weighting to words from the content based at least in part on the source of the content; and
a module for creating a mapping of the words from the content based at least in part on the events corresponding with the words.

17. A computer program product for generating content based on a persona, the computer program product comprising:
a computer readable storage medium having computer readable program code embodied therewith, the computer readable program code comprising:
computer readable program code configured to analyze one or more events identified by one or more persona triggers resulting in one or more event characteristics, the one or more persona triggers each indicate an event has occurred and generating content by the persona in response to the event occurring;
computer readable program code configured to perform a comparison between the one or more event characteristics and one or more persona parameters; and
computer readable program code configured to generate content by the persona based at least in part on the comparison between the one or more event characteristics and the one or more persona parameters.

18. The computer program product of claim 17, wherein the computer readable program code further comprises:
computer readable program code configured to search a network to identify one or more of the persona triggers indicating the event has occurred to which the persona generates content.

19. The computer program product of claim 17, wherein the computer readable program code further comprises:
computer readable program code configured to retrieve source content from one or more content providers; and
computer readable program code configured to process the source content to create the persona.

20. The computer program product of claim 19, wherein the computer readable program code further comprises:
computer readable program code configured to process the source content to create at least one of the one or more persona parameters and at least one of the one or more persona triggers;
computer readable program code configured to analyze the content for relevance to recent publications or events; and
computer readable program code configured to add words from the content to a dictionary comprising:
computer readable program code configured to apply weighting to words from the content based at least in part on the source of the content; and
computer readable program code configured to create a mapping of the words from the content based at least in part on the events corresponding with the words.

21. The method of claim 1, wherein generating content comprises at least one of generating a response message and a forward message.
